(19) United States
(12) Patent Application Publication
(10) Pub. No.: US 2003/0192163 A1
(43) Pub. Date: Oct. 16, 2003

(54) Method of inserting metal heat dissipaters into electronics enclosures

(76) Inventor: John M. Lipari, Sussex, NJ (US)

Correspondence Address: Eugene C. Rzucidlo, Esq., Greenberg Traurig, LLP, 21st Floor, 885 Third Avenue, New York, NY, 10022, US

(21) Appl. No.: 10/119,455

(22) Filed: Apr. 10, 2002

(51) Int. Cl. B23P 11/00

(52) U.S. Cl. 29/505

(57) ABSTRACT

A method for inserting a heat port into a stamped base unit includes manufacturing a heat port from a hard metal and providing the heat port with a flange and a recessed locking area. The base unit is provided with a counterbored base hole, the base hole including a counterbore area. The heat port is stamped into the counterbored base hole so that the heat port flange coins the base unit material by the counterbore area into the recessed locking area of the heat port.

### FIELD OF THE INVENTION

The invention is directed to a method of inserting metal heat dissipaters by means of a stamping operation into hermetic or non-hermetic enclosures used in the electronics industry.

### BACKGROUND OF INVENTION

It is currently the state of the art to machine expensive base plates, which act as heat dissipaters for electronics inside a package. These heat dissipaters are commonly made of materials such as copper, molybdenum, copper-molybdenum, and cooper-tungsten. Other materials can be used such as Aluminum, AlSiC, silver, gold, and post plated materials. These base plates or heat dissipaters are then brazed to glass-to-metal sealed kovar or CRS frames. Most of the expense of the package at that point is attributed to the material cost of the heat dissipative alloys and the extensive machining required.

### SUMMARY OF INVENTION

It is the object of the invention to provide an economical method for inserting heat dissipative plugs into electronic enclosures where needed to suit the electronic characteristics of the package. The plugs are made to the required size and shape as needed to provide appropriate heat dissipation for the electronic package. The plugs are made in an appropriate manufacturing process such as a screw machine. This greatly minimizes the material cost and manufacturing cost of the heat dissipaters. Currently, hermeticity has only been checked for kovar and copper-tungsten dissipaters. Other shapes and designs are possible.

The plugs are then inserted into a counterbored hole in the electronic package through a coining operation. The stamping operation wedges the two pieces together and provides a hermetic seal.

### BRIEF DESCRIPTION OF THE DRAWINGS

FIG. 1 depicts a perspective view of one embodiment of heat dissipative plug of the present invention.

FIG. 2 depicts a perspective view of a mating electronic enclosure for the plug of FIG. 1.

FIG. 3A depicts a cross-sectional area of a hard metal heat port and base plate prior to stamping.

FIG. 3B depicts a cross-sectional area of a hard metal heat port and base plate after stamping.

FIG. 4A depicts a cross-sectional area of a soft metal heat port and base plate prior to stamping.

FIG. 4B depicts a cross-sectional area of a soft metal heat port and base plate after stamping.

### DETAILED DESCRIPTION OF THE INVENTION

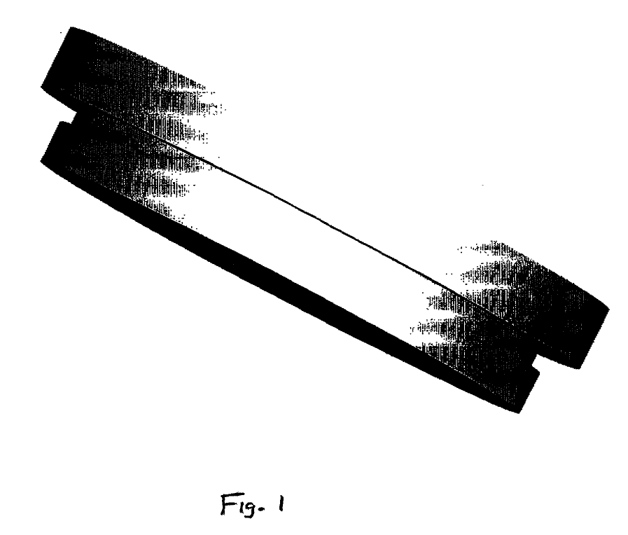

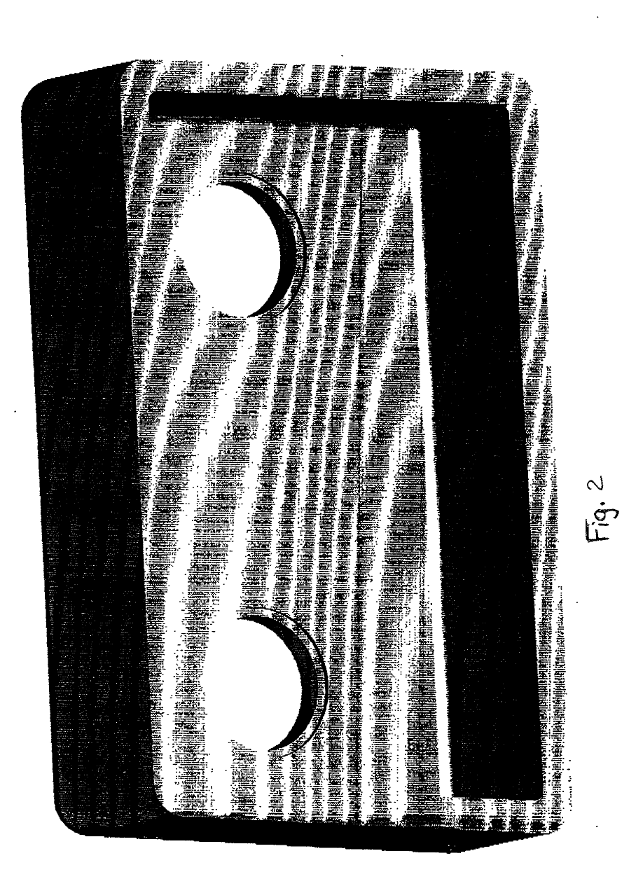

The insertion of heat ports into stamped base plates or tubs to form a hermetic seal is accomplished through a stamping process. The heat ports are manufactured from materials with good heat dissipation qualities, such as copper, molybdenum, copper-tungsten, copper-molybdenum, etc. The materials used for the bases or tubs include kovar, CRS, nickel-iron alloys, etc. Normally, the selection of one of these materials is made to control the thermal expansion of the plate. FIG. 1 depicts an exemplary heat dissipative plug, while FIG. 2 depicts an exemplary mating electronic enclosure into which the plug of FIG. 1 is stamped.

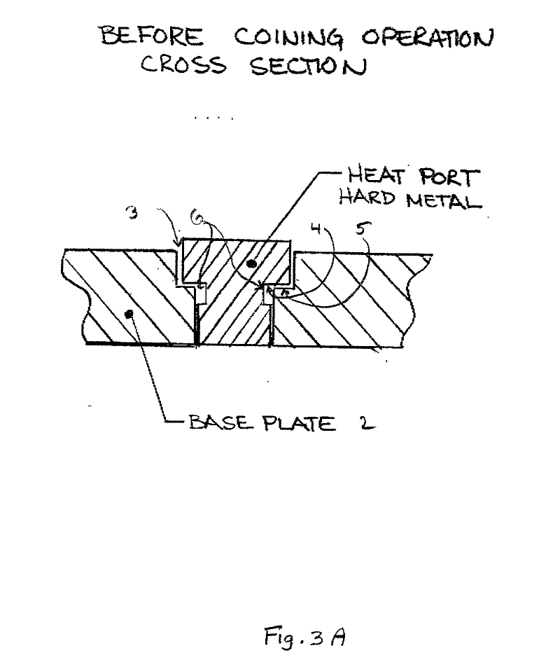

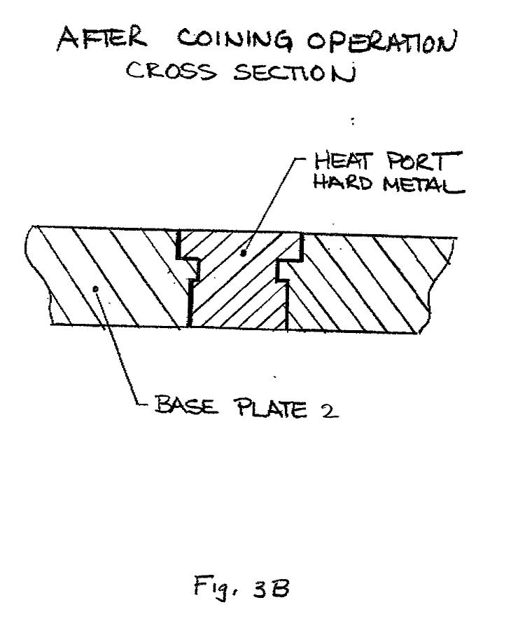

The inventors have developed a process for use with hard materials, such as molybdenum, copper-tungsten, and copper-molybdenum, that employs a locking system. FIGS. 3A and 3B illustrates the manner in which the mating materials are combined.

The heat port 1 is manufactured through a machining or molding process and is electroless nickel-plated. The base 2 is either stamped or machined and left unplated. The port 1 and base 2 are combined in a simple coining process where the heat port 1 is forced into the counterbored base hole 3. The heat port flange 4 coins the material from the softer base by the counterbore area 5 and the base material is forced into the recessed locking area 6 of the heat port. The newly attached pieces are now sent through a furnace to melt the plating to further fuse the materials together. After this process, the base is ground to assure flatness. The final product is shown in FIG. 3B.

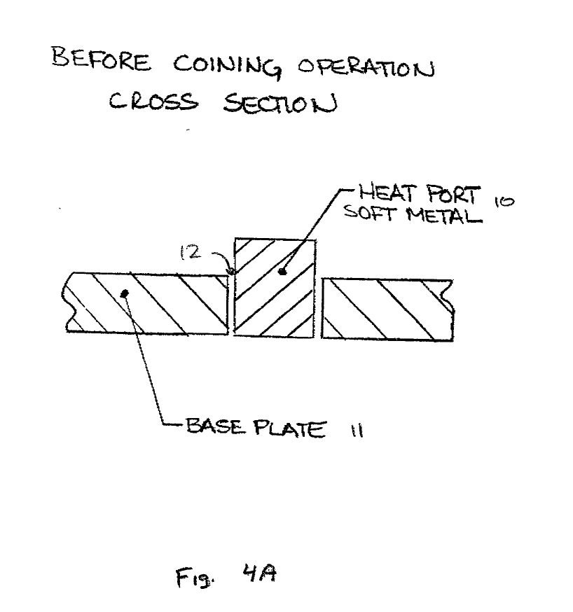

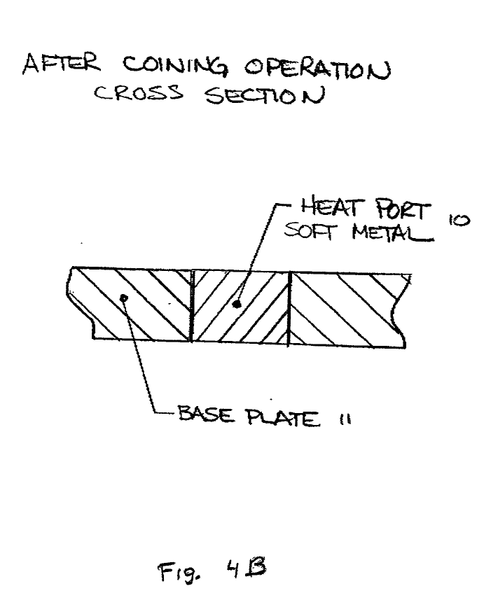

With copper and softer, more malleable heat port materials, the heat ports and base plates are designed as illustrated in FIGS. 4A and 4B. As can be seen, the heat port 10 is smaller in diameter than the hole 12 in the base plate 11 but greater in height than the base plate 11. The heat port 10 is once again electroless nickel-plated. The heat port 10 is placed in the hole 12 in the base plate 11 and coined. Upon coining the heat port 10, the heat port 10 becomes smaller in height and larger in diameter. The heat port 10 eventually locks tightly into the hole 12 in the base 11, as shown in FIG. 4B. The combined unit is then passed through a furnace to melt the electroless nickel plating, which helps fuse the materials together.

An advantage of this invention is that the manufacture of base plates for the microelectronics industry is much more cost effective than in the past. Presently, where controlling thermal expansion rates and heat dissipation are important factors in the design of an electronic package, base plates are made of molybdenum, copper-molybdenum, or copper-tungsten. These materials are all very difficult or impossible to stamp. They are all powdered materials that are very expensive. The process of the present invention allows the use of inexpensive and easy to stamp materials for the base and either inexpensive copper for the heat ports, or a much lesser amount of expensive material if the heat port selection is copper-tungsten, copper-molybdenum, or molybdenum. The optimal heat port material for use with the process of the invention is copper. Copper is the most manufacturable of all heat port materials and the least expensive. The process of the invention can provide heat dissipation characteristics superior to molybdenum, copper-tungsten, and copper-molybdenum, while also controlling the thermal expansion of the plates through proper volume design and placement of the heat port within the base plate.

While the present invention has been described and illustrated in various preferred and alternate embodiments, such descriptions and illustrations are not to be construed to be limitations thereof. Accordingly, the present invention encompasses any variations, modifications and/or alternate embodiments with the scope of the present invention being limited only by the claims which follow.

What is claimed is:

1. A method for inserting a heat port into a stamped base unit comprising the steps of:
manufacturing a metallic heat port;
providing said metallic heat port with a flange and a recessed locking area;
forming a counterbored base hole in a base unit;
forming a counterbore area in said base hole; and
stamping the metallic heat port into the counterbored base hole so that the metallic heat port flange coins the base unit material by the counterbore area into the recessed locking area of the heat port.

2. The method of claim 1, further comprising the steps of:
heating the attached heat bore and base unit in a furnace to fuse them together; and
grinding the combined heat port and base unit to insure flatness.

3. The method of claim 1, wherein the metallic heat port is comprised of molybdenum, copper-tungsten, or copper-molybdenum.

4. The method of claim 1, wherein the metallic heat port is electroless nickel-plated.

5. The method of claim 1, wherein the base unit is unplated.

6. The method of claim 1, wherein the height of the heat port is greater than the thickness of the base unit.

7. A method for inserting a heat port into a stamped base unit comprising the steps of:
forming a base hole in a base unit;
manufacturing a heat port from a malleable metal, wherein the height of the heat port is greater than the thickness of the base unit, and the diameter of the heat port is less than the diameter of the base hole; and
stamping the heat port into the base hole to compress the height of the heat port and expand the diameter of the heat port so as lock the heat port into the base hole.

8. The method of claim 7, further comprising the steps of:
heating the attached heat bore and base unit in a furnace to fuse them together; and
grinding the combined heat port and base unit to insure flatness.

9. The method of claim 7, wherein the heat port is electroless nickel-plated.

10. The method of claim 7, wherein the base unit is unplated.
